(19) United States
(12) Patent Application Publication
(10) Pub. No.: US 2002/0049821 A1
(43) Pub. Date: Apr. 25, 2002

(54) Document transmission apparatus and storage medium in which program for document transmission apparatus is stored

(75) Inventor: Tamae Hashimoto, Tokyo (JP)

Correspondence Address: SUGHRUE, MION, ZINN, MACPEAK & SEAS, 2100 Pennsylvania Avenue N.W., Washington, DC, 20037-3202, US

(73) Assignee: NEC CORPORATION

(21) Appl. No.: 09/960,344

(22) Filed: Sep. 24, 2001

(30) Foreign Application Priority Data
Sep. 25, 2000 (JP) 2000-290036

(51) Int. Cl. G06F 15/16; G06F 15/00; G06F 17/21; G06F 17/24

(52) U.S. Cl. 709/206; 707/500

(57) ABSTRACT

A document transmission apparatus which can selectively note down such information as a standardized sentence which is used frequently on a transmittal letter produced automatically thereby is disclosed. The document transmission apparatus includes a document data transmission section for producing document data, a transmittal letter production section for producing a transmittal letter to be attached to the document data, a transmission section for electronically transmitting the document data with the transmittal letter attached, an additional information storage section in which a plurality of pieces of additional information which can be attached to the transmittal letter are stored, and an operation section for selecting an arbitrary one of the pieces of additional information from within the additional information storage section. The transmittal letter production section produces a transmittal letter in which the additional information selected by the operation section is inserted.

### BACKGROUND OF THE INVENTION

1. Field of the Invention

The present invention relates to a document transmission apparatus, and more particularly to a document transmission apparatus which can automatically produce a letter of transmittal and transmit it together with a document and a storage medium in which a program for a document transmission apparatus is stored.

2. Description of the Related Art

A document transmission apparatus is conventionally known which transmits document data obtained by reading an original by means of a scanner or the like or some other data to a facsimile apparatus over a public network or transfers such document data or like data as an electronic mail to an opposite terminal over the Internet or a local area network (hereinafter referred to as LAN). When it is intended to use a document transmission apparatus of the type mentioned to send document information to a facsimile apparatus or an opposite terminal, usually a “letter of transmittal” (hereinafter referred to as transmittal letter) is sent before the document information itself is sent. Normally, a transmittal letter has a destination, a source of transmission, a number of pages to be transmitted, date and time, a business (title) and so forth noted down thereon. A transmitting person itself produces a transmittal letter from paper, actually adds the produced transmittal letter before the top page of the document and sets the transmittal letter and the document in position into a scanner or the like to transmit the information.

In recent years, a document transmission apparatus has been proposed which automatically produces a transmittal letter to augment the convenience and the operability. For example, a document transmission apparatus disclosed in Japanese Patent Laid-Open No. 215339/1999 automatically produces, upon transmission of an original read, a transmittal letter on which a destination, date and time, a number of pages to be transmitted, a transmitting person and so forth are noted down and transmits the transmittal letter together with the original. The document transmission apparatus is augmented in convenience and operability because it has a function of automatically producing and transmitting a transmittal letter on which necessary information is noted down every time.

The document transmission apparatus, however, is disadvantageous in that it cannot note down, on an automatically produced transmittal letter, such information as a standardized sentence which is not required every time like an item to be conveyed to a transmission destination but is used frequently.

### SUMMARY OF THE INVENTION

It is an object of the present invention to provide a document transmission apparatus which can selectively note down such information as a standardized sentence which is used frequently on a transmittal letter produced automatically thereby.

In order to attain the object described above, according to an aspect of the present invention, there is provided a document transmission apparatus, comprising a document data transmission section for producingdocument data, a transmittal letter production section for producing a transmittal letter to be attached to the document data, a transmission section for electronically transmitting the document data with the transmittal letter attached, an additional information storage section inwhicha plurality of pieces of additional information which can be attached to the transmittal letter are stored, and an operation section for selecting an arbitrary one of the pieces of additional information from within the additional information storage section, the transmittal letter production section producing a transmittal letter in which the additional information selected by the operation section is inserted.

With the document transmission apparatus, such information as a standardized sentence which is used very frequency can be selectively noted down into a transmittal letter which is automatically produced by the document transmission apparatus and is to be attached to and transmitted together with document data to be transmitted. Consequently, the document transmission apparatus can be used with augmented convenience to the user.

The operation section may include a display section for displaying the additional information stored in the additional information storage section, and a selection input section for arbitrarily selecting the additional information displayed on the display section. With the document transmission apparatus, the user can select an arbitrary one of the pieces of additional information displayed on the display section. Consequently, insertion of additional information into a transmittal letter is simplified, and this augments the convenience and the operability to the user.

In this instance, the document transmission apparatus may be configured such that the additional information storage section stores a registration number and a title for each of the pieces of additional information and the display section displays at least the registration numbers and the titles of the pieces of additional information as a list, and the selection input section designates one of the displayed registration numbers to select the additional information and the transmittal letter production section inserts a text of the selected additional information into the transmittal letter. With the document transmission apparatus, the registration numbers and the titles of the pieces of additional information are displayed as a list on the display section, and if the user designates one of the registration numbers displayed on the display section to select an arbitrary one of the pieces of additional information, then the text of the selected additional information is inserted into the transmittal letter. Consequently, selection of additional information is facilitated.

The document transmission apparatus may further comprise additional information registration means for additionally storing new additional information into the additional information storage section. With the document transmission apparatus, new additional information can be stored additionally into the additional information storage section. Consequently, the user can register necessary additional information.

According to another aspect of the present invention, there is provided a recording medium on which a program for a document transmission apparatus which includes a document data transmission section for producing document data, a transmittal letter production section for producing a transmittal letter to be attached to the document data, and a transmission section for electronically transmitting the document data with the transmittal letter attached is stored, the program causing the document transmission apparatus to have an additional information selection function of selecting, from within an additional information storage section in which a plurality of pieces of additional information which can be attached to the transmittal letter are stored, an arbitrary one of the pieces of additional information, and an additional information insertion function of inserting the selected arbitrary one of the pieces of additional information into the transmittal letter produced by the transmittal letter production section.

The additional information selection function may include a display function of displaying the additional information stored in the additional information storage section on a display section, and a selection function of arbitrarily selecting the additional information displayed on the display section.

The program may be configured such that it further causes the document transmission apparatus to have an additional information storage function of storing a registration number, a title and a text of each of the pieces of additional information into an additional information storage section and the display function displays at least the registration numbers and the titles of the pieces of additional information stored in the additional information storage section as a list, and the selection function designates one of the displayed registration numbers to select the additional information and the transmittal letter insertion function inserts the text of the selected additional information into the transmittal letter.

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1 is a block diagram showing a configuration of a document transmission apparatus according to which the present invention is applied;

FIG. 2 is a block diagram showing an external connection situation of the document transmission apparatus of FIG. 1;

FIG. 3 is a table illustrating an example of additional information stored in an additional information storage section of the document transmission apparatus of FIG. 1;

FIG. 4 is a block diagram showing a hardware configuration of the document transmission apparatus of FIG. 1;

FIG. 5 is a schematic view showing an example of an operation section of the document transmission apparatus of FIG. 1;

FIG. 6 is a flow chart illustrating an operation method of the document transmission apparatus of FIG. 1;

FIG. 7 is a f low chart ill ustrating facsimil e transmission operation of the document transmission apparatus of FIG. 1;

FIG. 8 is a schematic view showing an example of a transmittal letter to which additional information is added;

FIG. 9 is a flow chart illustrating electronic mail transmission operation of the document transmission apparatus of FIG. 1;

FIG. 10 is a schematic view showing an additional information list screen accessed from a PC which includes a web viewer; and

FIG. 11 is a schematic view showing an example of a transmittal letter additional information editing screen displayed on the web viewer.

### DESCRIPTION OF THE PREFERRED EMBODIMENT

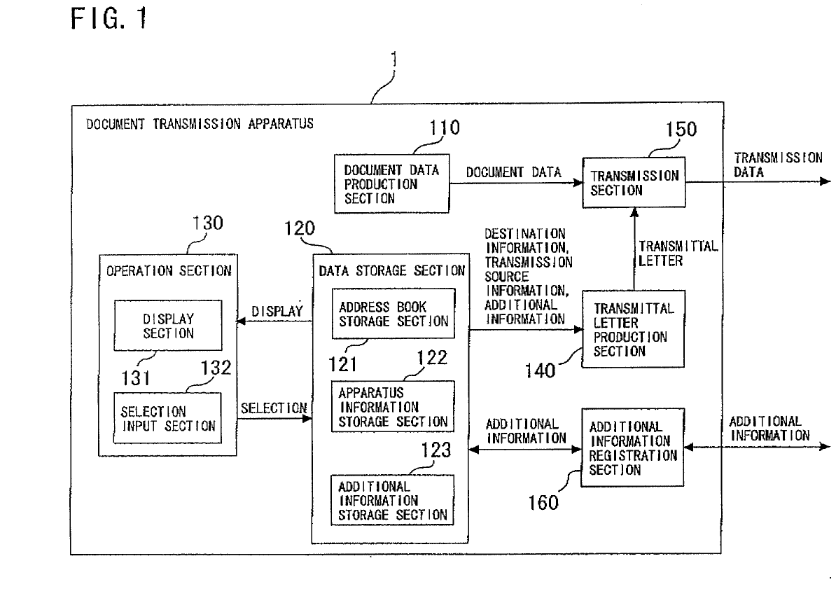

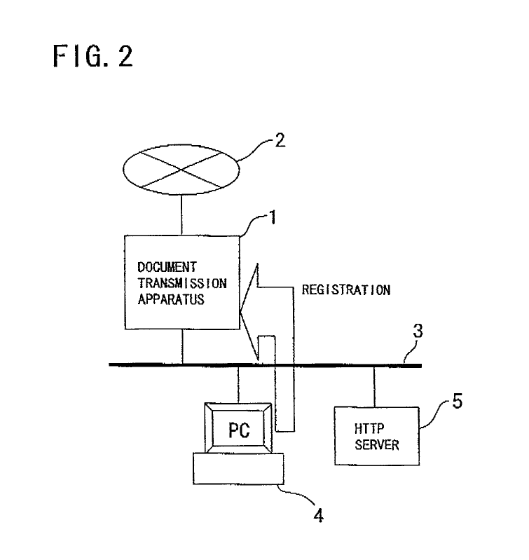

Referring first to FIG. 1, there is shown a configuration of a document transmission apparatus to which the present invention is applied. The document transmission apparatus is generally denoted at 1 and includes a document data production section 110, a data storage section 120, an operation section 130, a transmittal letter production section 140, a transmission section 150, andan additional information registration section 160. The document transmission apparatus 1 is connected to a public network 2 and a LAN 3 as shown in FIG. 2. A personal computer (hereinafter referred to as PC) 4 having a web viewer and an HTTP (HyperText Transfer Protocol) server 5 are connected to the LAN 3.

The document transmission apparatus 1 is configured to select and perform one of a facsimile transmission function of converting document data and a transmittal letter into facsimile data, connecting itself to the public network 2 and transmitting the facsimile data to an opposite facsimile and an electronic mail transmission function of converting document data and a transmittal letter into data of an electronic mail format, connecting itself to the LAN 3 and transmitting the data of the electronic mail format to an opposite terminal through the HTTP server 5. The document data production section 110 has a function of producing document data of a document to be transmitted and out putting the document data to the transmission section 150. More particularly, the document data production section 110 reads a document to be transmitted, and produces image data of the document and outputs the image data to the transmission section 150.

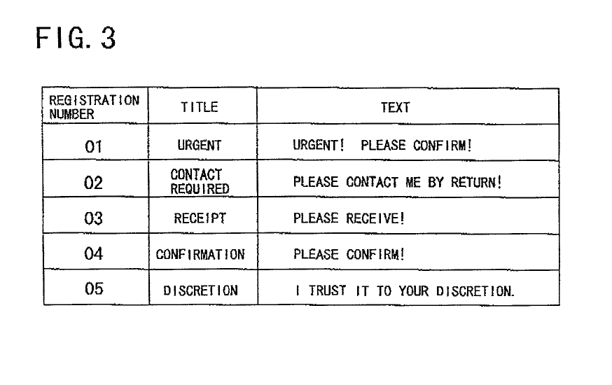

The data storage section 120 is non-volatility storage means for storing various data to be used when the document transmission apparatus operates, and includes an address book storage section 121, an apparatus information storage section 122, and an additional information storage section 123. The address book storage section 121 stores an address book in which names of destination and telephone numbers for facsimile transmission and electronic mail addresses corresponding to the names of destination and so forth are recorded. The apparatus information storage section 122 stores apparatus parameters such as transmission source information and initial set values necessary for operation of the document transmission apparatus. The additional information storage section 123 stores additional information which can be added to a transmittal letter. An example of additional information stored in the additional information storage section 123 is illustrated in FIG. 3. As seen in FIG. 3, one piece or set of additional information includes a registration number, a title and a text, which are individually formed from character strings stored in storage areas of predetermined lengths.

The operation section 130 is operation means having a function of selecting arbitrary additional information from within the additional information storage section 123. The additional information storage section 123 includes a display section 131 having a function of displaying the additional information stored in the additional information storage section 123, and a selection input section 132 having a function of selecting arbitrary additional information displayed on the display section 131. The display section 131 reads out and shapes the additional information stored in the addition information storage section 123 and produces and displays an additional information list including a registration number and a title. The selection input section 132 reads out the text of the selected additional information based on the registration number of the additional information list selected by the user from the additional information storage section 123 and outputs it to the transmittal letter production section 140. Further, the operation section 130 is operation means of the document transmission apparatus 1 and has not only the function described above but also a function relating to another operation for using the document transmission apparatus 1.

The transmittal letter production section 140 has a function of producing a transmittal letter to be annexed to document data in which arbitrary additional information selected from within the additional information storage section 123 is inserted and outputs the produced transmittal letter to the transmission section 150. More particularly, the transmittal letter production section 140 produces a transmittal letter which includes transmission date and time, a destination and a number of pages to be transmitted which are to be combined to make one sentence, and a transmission column, and inserts arbitrary additional information selected from within the additional information storage section 123 into the transmittal letter and outputs the transmittal letter to the transmission section 150. In this instance, the text of the additional information is inserted into the transmittal letter. It is to be noted that, when the facsimile transmission function is used, the number of pages to be transmitted is set to the number of pages of the document and the number of pages of the transmittal letter, but when the electronic mail transmission function is used, the number of pages to be transmitted is set to the number of pages of the document.

The transmission section 150 has a function of attaching a transmittal letter to document data produced by the document data production section 110 and electronically transmitting the resulting data. If the facsimile transmission function is selected, then the transmission section 150 converts a transmittal letter outputted from the transmittal letter production section 140 into image data, couples the image data to image data of a document for transmission outputted from the document data production section 110, encodes the resulting image data by a predetermined facsimile transmission procedure such as, for example, the group 3 standards, connects itself to the public network 2 and successively transmits the image data to an opposite facsimile.

On the other hand, if the electronic mail transmission function is selected, then the transmission section 150 places an electronic mail address of a transmission destination obtained by referring to the address book stored in the address book storage section 121 and an electronic mail address of a transmission source obtained by referring to transmission source information stored in the apparatus information storage section 122 into the header part of an electronic mail, and arranges a transmittal letter outputted from the transmittal letter production section 140 to the textpart of text information of the electronic mail as a character string oftext data. Then, the transmission section 150 performs predetermined encoding of image data of a document for transmission outputted from the document data production section 110 to make an attached file to the electronic mail. Thereafter, the transmission section 150 establishes a connection to the LAN 3 and transmits the electronic mail together with the attached file.

The additional information registration section 160 has a function of storing a new additional information into the additional information storage section 123. The additional information registration section 160 further has a function of converting the additional information stored in the additional information storage section 123 into a file of the HTML (Hyper Text Markup Language) format, a WWW (World Wide Web) server function of instructing to the PC 4, which includes a web viewer and is connected thereto through the LAN 3, to access the additional information of the file of the HTML format or to edit the additional information in a designated format, and a function of converting the edited file of the HTML format into a file of a storage format for the additional information storage section 123 and storing the resulting file into the additional information storage section 123. Consequently, the additional information registration section 160 can perform new registration, deletion and modification to contents of additional information.

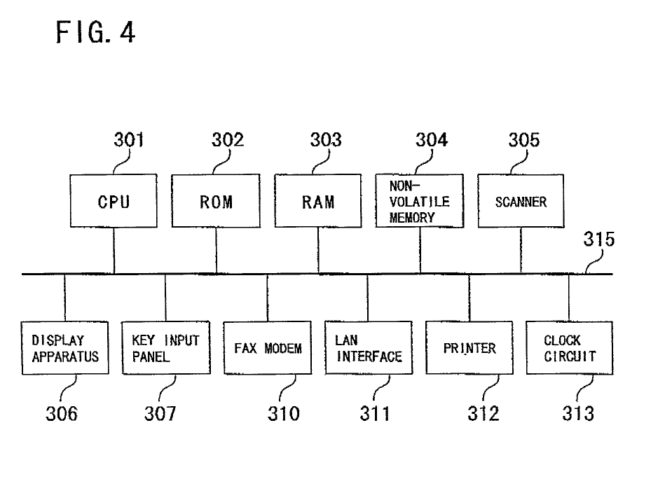

In the following, implementation of the components of the document transmission apparatus shown in FIG. 1 is described. FIG. 4 shows a configuration of hardware of the document transmission apparatus. Referring to FIG. 4, the document transmission apparatus shown includes a central processing unit (hereinafter referred to as CPU) 301, a read only memory (hereinafter referred to as ROM) 302, a random access memory (hereinafter referred to as RAM) 303, a non-volatile memory 304, a scanner 305, a display apparatus 306, an operation panel 307, a FAX (facsimile) modem 310, a LAN interface 311, a printer 312, and a clock circuit 313. The components mentioned are connected to one another by a system bus 315.

In the document transmission apparatus, the CPU 301 refers to data stored in the non-volatile memory 304 based on a program stored in the ROM 302, and uses the RAM 303 as a working area to execute operation of the document transmission apparatus. The ROM 302 stores a program for implementing the functions of the operation section 130, a program for implementing the function of the transmittal letter production section 140, a program for realizing a function of the transmission section 150, a program for implementing the functions of the additional information registration section 160, and a program for controlling the scanner 305, display apparatus 306, operation panel 307, FAX modem 310, LAN interface 311, printer 312 and clock circuit 313 connected thereto by the system bus 315. The CPU 301 executes the programs so that the document transmission apparatus operates as such.

The non-volatile memory 304 is used as the data storage section 120 and includes the address book storage section 121, apparatus information storage section 122 and additional information storage section 123. The non-volatile memory 304 is formed from a semiconductor memory which allows reading and writing and does not lose written data even if power supply is switched off such as, for example, a flash memory or a static RAM backed up by a battery. The scanner 305 outputs a document as read image data with a predetermined resolution and operates as the document data production section 110.

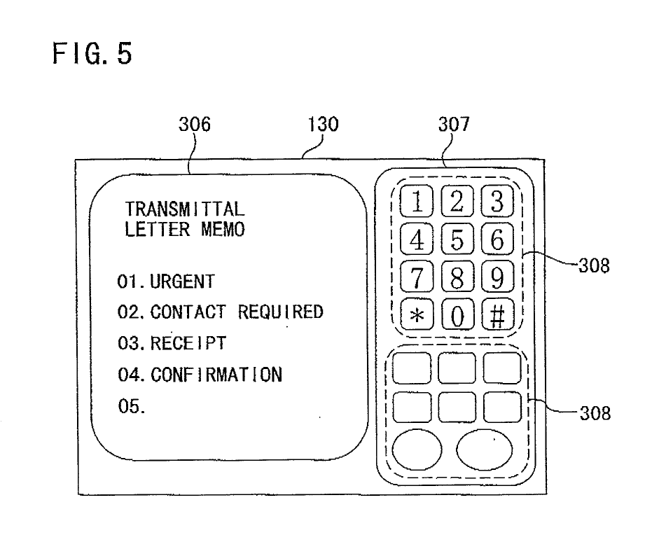

The display apparatus 306 and the operation panel 307 operate as part of the display section 131 and the selection input section 132 which form the operation section 130. FIG. 5 shows an example of the operation section 130. The display apparatus 306 is formed from, for example, a liquid crystal display panel or the like, and displays registration numbers and titles of a plurality of pieces or sets of additional information stored in the additional information storage section 123 in the form of a list. The operation panel 307 includes a ten-key input section 308 and function key input section 309. The ten-key input section 308 includes numeral keys of 0 to 9, a “*” key, and a “#” key. The function key input section 309 includes a “start” key for starting transmission of a document, a “stop” key for stopping transmission of a document, a function key for selecting a transmission method, another function key for establishing a mode in which the numeral keys are used to input character data.

The FAX modem 310 and the LAN interface 311 operate as transmission means of the transmission section 150. The FAX modem 310 establishes a connection to the public network 2 and transmits facsimile data to an opposite facsimile. The LAN interface 311 is provided to establish a connection to the LAN 3 and transmit an electronic mail to an opposite terminal through the HTTP server 5 or instruct the PC 4 which includes the web viewer to perform registration of additional information in accordance with a designated format. The printer 312 is used to copy a document to be transmitted or print various kinds of information registered in the document transmission apparatus. The clock circuit 313 outputs present time information which indicates transmission date and time of a transmittal letter.

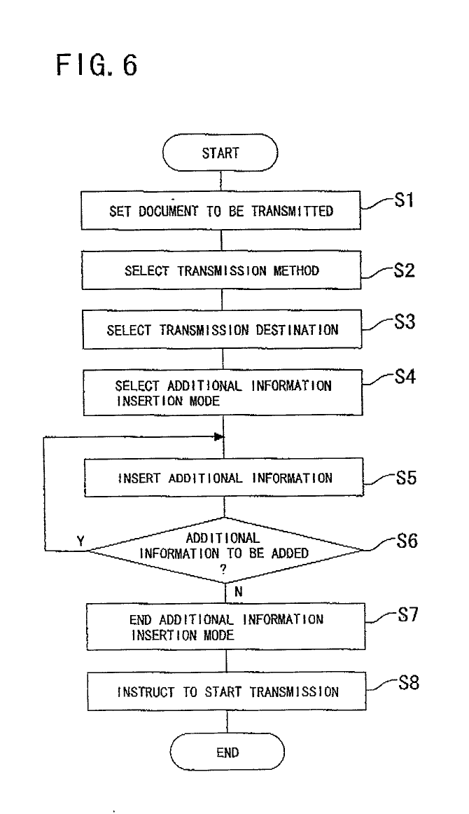

In the following, an operation method of the document transmission apparatus is described with reference to a flow chart of FIG. 6. The user will set a document to be transmitted in position into the scanner 305 (step S1) and select the facsimile transmission or the electronic mail transmission by operating the function key input section 309 of the operation panel 307 (step s2). Consequently, the address book stored in the non-volatile memory 304 is read out and shaped, and is inputted as an address list including registration numbers and names of the transmission destinations to the display apparatus 306. Then, the address list is displayed on the display apparatus 306. Thus, the user will input a registration number of a transmission destination to which a document is to be transmitted to select the transmission destination by operating the ten-key input section 308 (step S3).

Then, the user will select an additional information insertion mode for inserting additional information into a transmittal letter by operating the function key input section 309 (step S4). Consequently, all registration numbers and all titles stored in the additional information storage section 110 of the non-volatile memory 304 are read out and shaped and then inputted as an additional information list to the display apparatus 306 so that the additional information list is displayed on the display apparatus 306. Thus, the user will input a registration number of additional information to be added to atransmittal letter and insert atext of the additional information by operating the ten-key input section 308 (step S5). The user will repeat the operation in step S5 until the additional information to be added to the transmittal letter remains no more (step S6). When all of the additional information to be added to the transmittal letter is inserted, the user will end the mode for inserting additional information into a transmittal letter by operating the function key input section 309 (step S7). Then, the user will issue an instruction to start transmission by operating the “start” key of the function key input section 309 (step S8). In this manner, the document transmission apparatus can add a text of additional information to a transmittal letter by simple operation.

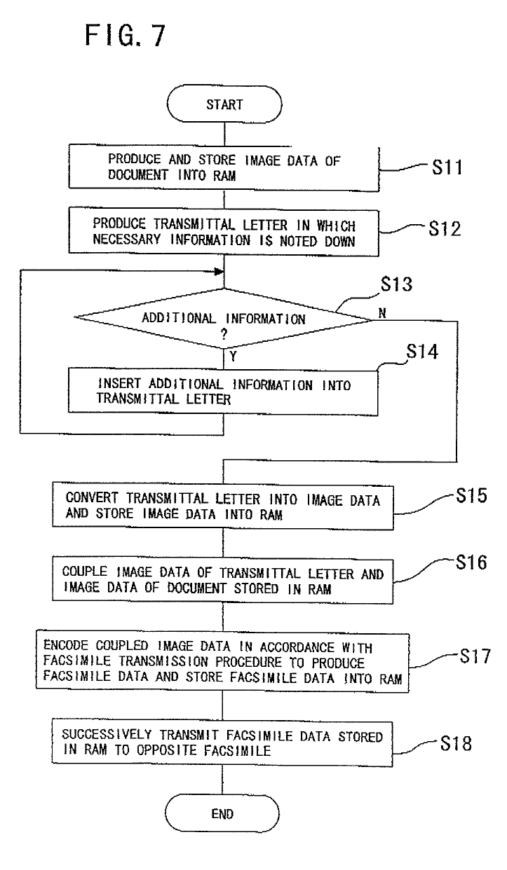

In the following, operation of the document transmission apparatus is described. First, operation for facsimile transmission of a document is described with reference to flow chart of FIG. 7. If the document transmission apparatus receives an instruction to start transmission, then the scanner 305 reads the document set thereon for each page to produce image data of the document and stores the produced data into the RAM 303 (step S11). Then, the transmittal letterproduction section 140 produces a transmittal letter on which necessary information including transmission date and time, a destination and a number of pages to be transmitted which are to be combined to make one sentence and a transmission source column are noted down (step S12).

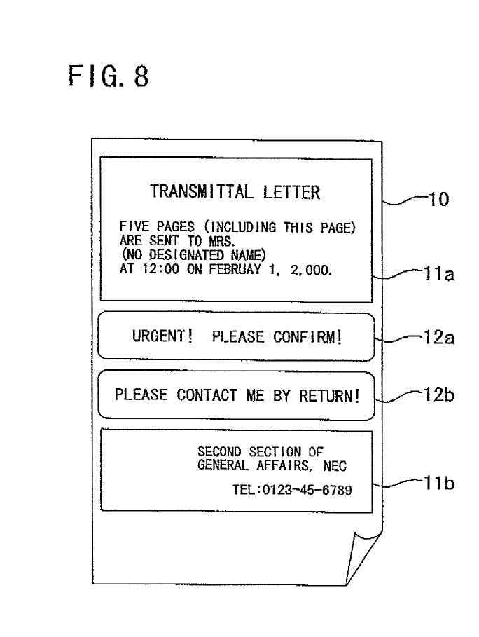

Thereafter, it is discriminated whether or not there is additional information (step S13). If there is additional information, then the text of the additional information is inserted into the transmittal letter (step S14). Thereafter, the processing returns to step S13, and the operations in steps S13 and S14 are repeated until there remains no additional information any more to complete the transmittal letter. FIG. 8 shows an example of a transmittal letter to which the text of additional information is added. Referring to FIG. 8, the transmittal letter 10 has an address column la for transmission date and time, a destination and a number of pages to be transmitted which are to be combined to make one sentence, a transmission source column 11b, and two text columns 12a and 12b for additional information.

If there remains no additional information and the transmittal letter is completed, then the transmittal letter is converted into image data and stored into the RAM 303 (step S15). Further, the image data of the transmittal letter and the image data of the document stored in the RAM 303 are read out and coupled to each other (step 816). The resulting data are decoded in accordance with the predetermined facsimile transmission procedure to produce facsimile data and the facsimile data are stored into the RAM 303 (step S17). Then, the document transmission apparatus is connected to the public network 2 through the FAX modem 310 and successively transmits the facsimile data stored in the RAM303 to the opposite facsimile (step S18). If the transmission is ended, then the connection to the public network is cut and the processing is ended.

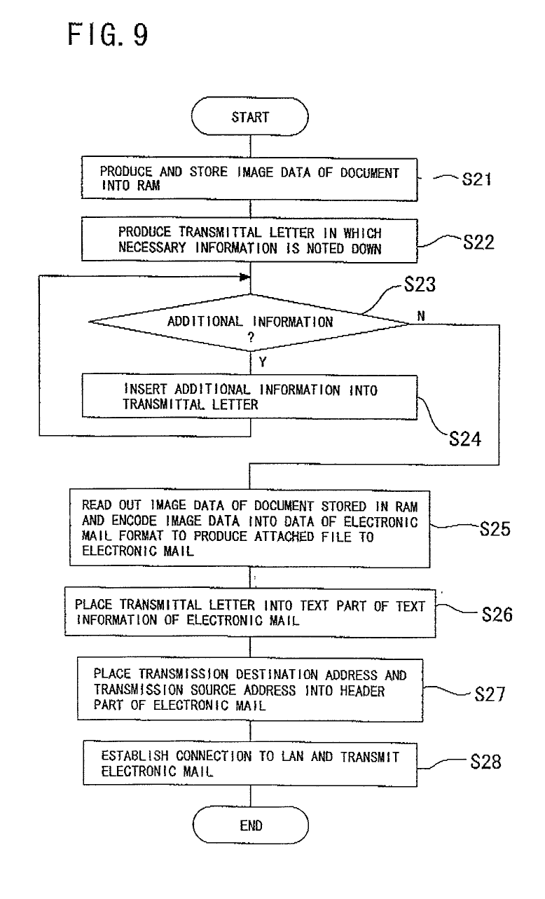

Now, operation of the document transmission apparatus when a document is transmittedby an electronic mail is described with reference to a flow chart of FIG. 9. When the document transmission apparatus receives an instruction to start transmission, the scanner 305 reads a document set therein for each page to produce image data of the document and stores the image data into the RAM 303 (step S21). Then, the transmittal letter production section 140 produces a transmittal letter on which necessary information including an address column including transmission date and time, a destination and a number of pages to be transmitted which are to be combined to make one sentence and a transmission source column (step S22). Thereafter, it is discriminated whether or not there remains additional information (step S23). If there remains additional information, then the text of additional information is inserted into the transmittal letter (step S24). Then, the processing returns to step S23 so that the operations in steps S23 and S24 are repeated until there remains no additional information to be added any more to complete the transmittal letter.

Thereafter, the image data of the document stored in the RAM 303 are read out and predetermined decoding conforming with an electronic mail format is performed for the image data to produce an attached file for an electronic mail (step S25). Then, the transmittal letter is placed as a character string of text data into the text part of text information of the electronic mail (step S26). Then, a transmission destination address and a transmission source address obtained by referring to the address list stored in the non-volatile memory 304 are placed into the header part of the electronic mail to complete the electronic mail (step S27). Thereafter, the document transmission apparatus establishes a connection to the LAN 3 through the LAN interface 311 and transmits the electronic mail to the opposite terminal through the HTTP server 5 (step S28). If the transmission is ended, then the connection to the LAN 3 is cut and the processing is ended.

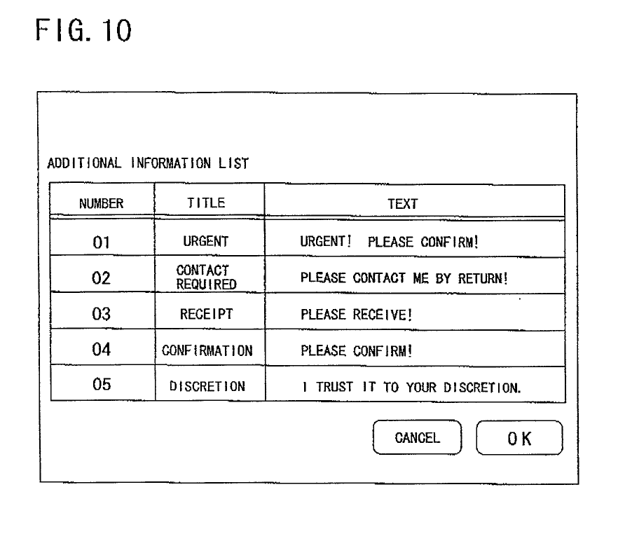

In the following, operation of the document transmission apparatus when additional information is registered into the additional information storage section 110 is described. The non-volatile memory 304 stores a file obtained by converting additional information stored in the additional information storage section 123 into data of the HTML format by means of the additional information registration section 160. The file can be read from the PC 4, which has the web viewer, connected thereto through the LAN 3 by accessing a WWW server of the additional information registration section 160. FIG. 10 shows an additional information list screen read from the PC 4 which has the web viewer.

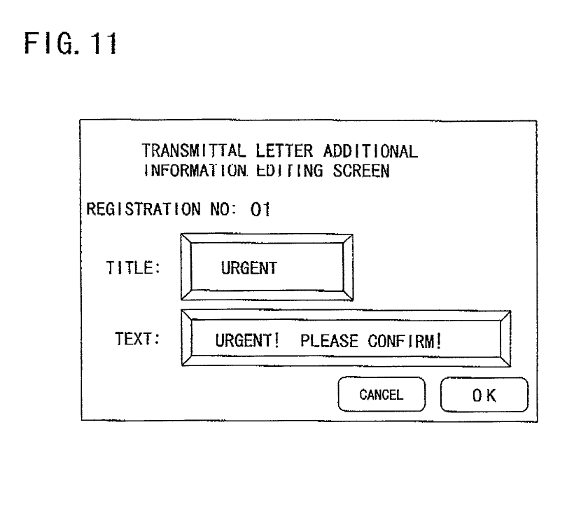

A tag is embedded in each registration number of the additional information list displayed by the web viewer, and a transmittal letter additional information editing screen of a registration number clicked by means of a mouse among the registration numbers is called and displayed on the web viewer. FIG. 11 shows an example of a transmittal letter additional information editing screen displayed on the web viewer. The transmittal letter additional information edition screen allows inputting of a title and a text, and inputted title and text are inputted to an additional information file of HTML format through the www server. As a result, data of the file are rewritten. The additional information file of the HTML format wherein the data have been rewritten is converted into data of a format for storage into the additional information storage section 123 by the additional information registration section 160 and is then stored into the additional information storage section 123. In this instance, additional information before the rewriting is erased. Consequently, new registration, deletion and contents modification of additional information can be performed.

As described above above, according to the document transmission apparatus of the embodiment, when it tries to convert a document to be transmitted into image data and transmit the image data to an opposite facsimile or an opposite terminal, it can selectively note down such information as a fixed form sentence, which is used with a high frequency, on a transmittal letter which is automatically produced. Consequently, the document transmission apparatus can achieve improvement in convenience and operability to the user. Further, accessing to or registration, editing or deletion of information which can be added to a transmittal letter can be performed from a PC which has a web viewer and is connected to the document transmission apparatus through a LAN, Consequently, the user can register necessary additional information.

While a preferred embodiment of the present invention has been described using specific terms, such description is for illustrative purposes only, and it is to be understood that changes and variations may be made without departing from the spirit or scope of the following claims.

What is claimed is:

1. A document transmission apparatus, comprising:
a document data transmission section for producing document data;
a transmittal letter production section for producing a transmittal letter to be attached to the document data;
a transmission section for electronically transmitting the document data with the transmittal letter attached;
an additional information storage section in which a plurality of pieces of additional information which can be attached to the transmittal letter are stored; and
an operation section for selecting an arbitrary one of the pieces of additional information from within said additional information storage section;
said transmittal letter production section producing a transmittal letter in which the additional information selected by said operation section is inserted.

2. A document transmission apparatusas claimed in claim 1, wherein said operation section includes a display section for displaying the additional information stored in said additional information storage section, and a selection input section for arbitrarily selecting the additional information displayed on said display section.

3. A document transmission apparatus as claimed in claim 2, wherein said additional information storage section stores a registration number and a title for each of the pieces of additional information and said display section displays at least the registration numbers and the titles of the pieces of additional information as a list, and said selection input section designates one of the displayed registration numbers to select the additional information and said transmittal letter production section inserts a text of the selected additional information into the transmittal letter.

4. A document transmission apparatus as claimed in claim 1, further comprising additional information registration means for additionally storing new additional information into said additional information storage section.

5. A recording medium on which a program for a document transmission apparatus which includes a document data transmission section for producing document data, a transmittal letter production section for producing a transmittal letter to be attached to the document data, and a transmission section for electronically transmitting the document data with the transmittal letter attached is stored, the program causing said document transmission apparatus to have:
an additional information selection function of selecting, from within an additional information storage section in which a plurality of pieces of additional information which can be attached to the transmittal letter are stored, an arbitrary one of the pieces of additional information; and
an additional information insertion function of inserting the selected arbitrary one of the pieces of additional information into the transmittal letter produced by said transmittal letter production section.

6. A storage medium as claimed in claim 5, wherein the additional information selection function includes a display function of displaying the additional information stored in said additional information storage section on a display section, and a selection function of arbitrarily selecting the additional information displayed on said display section.

7. A recording medium as claimed in claim 5, wherein the program further causes said document transmission apparatus to have an additional information storage function of storing a registration number, a title and a text of each of the pieces of additional information into an additional information storage section and the display function displays at least the registration numbers and the titles of the pieces of additional information stored in said additional information storage section as a list, and the selection function designates one of the displayed registration numbers to select the additional information and the transmittal letter insertion function inserts the text of the selected additional information into the transmittal letter.
